(19) United States
(12) Patent Application Publication
(10) Pub. No.: US 2021/0298270 A1
(43) Pub. Date: Sep. 30, 2021

(54) Dog excrement catcher with adapted disposable bags

(71) Applicant: Jennifer Reevey, Seattle, WA (US)

(72) Inventor: Jennifer Reevey, Seattle, WA (US)

(21) Appl. No.: 16/831,800

(22) Filed: Mar. 27, 2020

(51) Int. Cl. A01K 23/00

(52) U.S. Cl. CPC A01K 23/005

(57) ABSTRACT

Described herein is an animal excrement collection device, the collection device having a handle and an end portion. The end portion adapted to receive a disposable bag and having a means within the end portion to close the bag from the handle.

### FIELD OF THE INVENTION

The invention relates generally to a dog excrement catching device with specialized disposable bags.

### BACKGROUND

Currently there are a number of solutions for picking up dog excrement. Most traditionally, the caretaker of the dog generally uses a bag over their hand to pick up the excrement, but this solution fails to meet the needs of the market because not all caretakers are able to bend over to pick it up. Another solution attempts to use a scooping device generally placed on an extended handle, but this solutions is similarly unable to meet the needs of the market because the scooping device needs to be cleaned. Still other solutions utilize a bag suspended under the dog during excretion, but this solution also fails to meet market needs because this solution requires the user to detach the generally open bag from the device prior to disposal.

### SUMMARY OF THE INVENTION

It would be advantageous to have an apparatus that closes a bag of dog excrement from an extended position. Furthermore, it would also be advantageous to have an apparatus that adjusted to the user's physical needs to collect dog waste. Still further, it would be advantageous to have an apparatus that closed a bag at the push of a button. Therefore, there currently exists a need in the market for an apparatus that catches dog excrement before it hits the ground.

The invention advantageously fills the aforementioned deficiencies by providing a dog excrement catcher with specifically adapted disposable bags, which provides adjustment options for reaching and catching the excrement.

The invention is portable.

The apparatus has a pull tab for an upper ring to secure the bag portion.

The apparatus has a cinching cord to generally close the disposable bag.

The apparatus fulfills the need for collecting animal waste without bending down.

Among other things, it is an advantage of the invention to provide a dog waste catching device with disposable bags that does not suffer from any of the problems or deficiencies associated with prior solutions.

It is still further an advantage of the invention to adjust to various angles. [0011] Still further, the apparatus has a handle with a trigger adapted to operate the cinching cord.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows the front of device.

FIG. 2 shows a perspective view of the device.

FIG. 3 shows the side of device.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The invention is a dog poop catcher with disposable bags.

The invention is reusable.

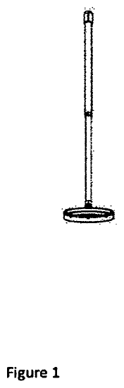

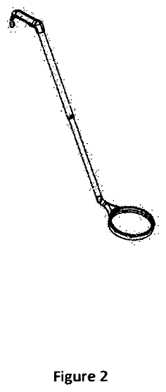

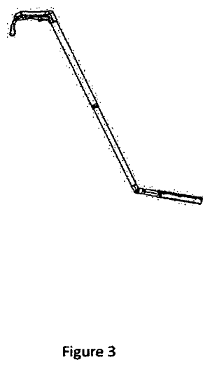

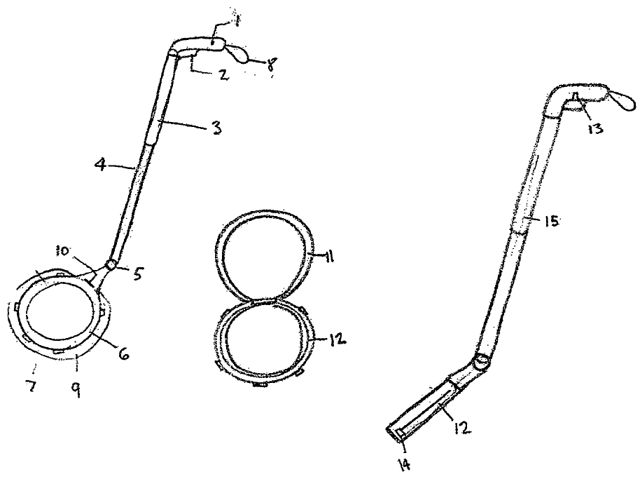

Referring to the figures, FIG. 1 to FIG. 3 show the dog excrement catching device with disposable bags according to the present disclosure. The device including a long handle with an adjustable bag holding end portion coupled to a trigger to generally manipulate the contents of the end portion. The end portion is generally circular and includes an upper ring portion having a tab to generally open the upper ring portion. The end portion connected to the handle portion with a connection that generally allows the end portion to be manipulated into various angels and positions.

The disposable bags of the disclosure are generally provided with an interior adhesive portion positioned at an upper portion around the circumference of the bag.

In use, the device end portion is used to the hold the bag, wherein the upper ring portion secures the disposable bag in an open position, wherein the bag is generally wrapped around the ring and held in place. The device is then moved to a position to catch the excrement within the bag portion. After collection, a trigger member is generally operated to cinch the disposable bag closed with a cable member received in the end portion. The cinching generally collapses the disposable bag upon itself, wherein the adhesive secures that closure of the disposable bag.

Various related embodiments of the invention are also described in Appendix A, which is incorporated herein by reference in its entirety.
While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. An Dog excrement Catcher with adapted Disposable bags device is comprised of:
a.) A pole that can retract and extend.
b.) A hoop with tabs going around it to help secure the grip of the bag.
c.) A hoop with a lid on top of it that is also hooped shaped.
d.) The device lid helps to hold the bad in place.
e.) The inner side of the hoop has a recess in it to hold the clench cord.
f.) The device has a clench cord to close the bags once triggered by the trigger on the handle.
g.) The hoop has a tab inside of the hoop to release the clench cord.
h.) The device has a trigger on the handle used to clench the bags closed.

2. The device of claim 1 has a pole that can be adjusted to extend or retract.

3. The device of claim 1 has a lid is attached to the hoop and closes over the device.

4. The device of claim 1 part that collects/catches the dog waste is connected by the pole by a joint.

5. The device of claim 1 has a handle with a trigger/button on it.

6. The device of claim 1 hoop has tabs that go around the circumference of the hoop.

7. The device of claim 1 has a wire that connects the trigger/button to the tab within the hoop. When the trigger is pressed the wire activates the tab releasing the clench cord causing it to retract back closing the bag.
How the device is used (Method of claim)(New):
The method of setting up the device for usage is:
Firstly, the lid is opened to allow usage.
Then the clench cord is set by putting the clench cord behind the tab.
The bag is then placed over the hoop, through the clench cord.
Once the bag is situated on the hoop the lid is then closed and the device is ready for use.
The method to remove the bag after usage is:
Once the device is used press the trigger/button on the handle to clench the bag.
Then the left the lid of the device and pull the bag away. The bag is then discarded.
